(19) United States
(12) Patent Application Publication
(10) Pub. No.: US 2025/0356633 A1
(43) Pub. Date: Nov. 20, 2025

(54) SYSTEM AND METHODS FOR CLASSIFICATION OF IMAGE DATA FROM SYNTHETIC APERTURE RADAR IMAGES AND ELECTRO-OPTICAL IMAGES

(71) Applicant: AtomBeam Technologies Inc., Moraga, CA (US)

(72) Inventors: Zhu Li, Overland Park, KS (US); Paras Maharjan, Kansas City, MO (US)

(21) Appl. No.: 18/665,235

(22) Filed: May 15, 2024

(51) Int. Cl. G06V 10/774; G06V 10/24; G06V 10/764; G06V 10/82; G06V 20/70

(52) U.S. Cl. CPC G06V 10/774; G06V 10/242; G06V 10/247; G06V 10/764; G06V 10/82; G06V 20/70

(57) ABSTRACT

Systems and methods are disclosed for image classification of electro-optical images and synthetic aperture radar images using training techniques that can include appearance labeling and triplet mining to train a neural network system. The training data can include image pairs of electro-optical images and synthetic radar aperture images. The training data can include anchor, positive, and negative images. The neural network can be trained using triplet loss and cross-entropy loss. The trained neural network can be used for object classification such as automatic target recognition of aerial images.

### CROSS-REFERENCE TO RELATED APPLICATIONS

Priority is claimed in the application data sheet to the following patents or patent applications, each of which is expressly incorporated herein by reference in its entirety:

None.

### BACKGROUND OF THE INVENTION

### Field of the Art

The present invention is in the field of image processing, and more particularly is directed to the problem of classifying objects in synthetic aperture radar images and electro-optical images.

### Discussion of the State of the Art

Electro-optical (EO) imagery includes still images captured with an electro-optical sensor, such as a high-resolution camera equipped with a telephoto zoom lens. This form of imagery detects the magnitude and color of emitted or reflected light and digitally records the information in the form of pixels. Electro-optical imagery has a wide range of applications such as environmental monitoring, surveillance and security, monitoring construction sites, and vehicular traffic monitoring, to name a few. Another important imaging technology is synthetic aperture radar (SAR). SAR can be complimentary to EO imagery. While EO imagery is easy to gather because it is illuminated by sunlight, EO imagery does not perform well in uneven lighting, darkness, and poor weather conditions. SAR imagery relies on radar data based on various wavelengths. The radar can include X-band radar, C-band radar, L-band radar, P-band radar, and/or other suitable radar frequencies. In aerial and/or satellite imagery, the wavelengths used by SAR can penetrate clouds, allowing SAR to acquire information at night and/or in cloudy conditions. Thus, SAR can be used for various applications, including environmental monitoring, agriculture, forestry, disaster monitoring, and military reconnaissance, among others, due to its ability to generate images regardless of weather conditions or time of day.

### SUMMARY OF THE INVENTION

Accordingly, there is disclosed herein, systems and methods for image classification that utilize sets of image data that can include both EO image data and SAR image data. Applications such as aerial photography and satellite imagery are capable of utilizing both types of image data. It can be desirable to automatically classify objects such as vehicles. More particularly, it can be desirable to classify vehicle types, such as a sedan, bus, box truck, and so on. However, performing such automatic classifications on these images can be challenging for various unique reasons. For one, these images tend to be low-resolution images. For example, SAR images may be of a resolution of 60×60 or less, while EO images may be of a resolution of 40×40 or less. The limited resolution can pose challenges for accurate object classification. Moreover, EO images and SAR images often lack proper pixel registration. The misalignment between the two modalities can add complexity to the classification task. Furthermore, an imbalanced class distribution can contribute to overfitting on classes in some cases. Additionally, images within the same class can have a high intra-class variance, while images of different classes can have a low inter-class variance, making it challenging to distinguish objects with subtle differences.

Disclosed embodiments address the aforementioned problems and shortcomings by performing label splitting, and appearance labeling utilizing a KD-tree, along with triplet mining, thereby creating a trained neural network system that can be used to classify image tuples, where the image tuples can include EO image data and/or SAR image data. The triplet mining can include analysis of anchor data, positive data, and negative data. The techniques disclosed herein can enable improved accuracy in object classification. The improved accuracy can be particularly beneficial for automatic target recognition (ATR). ATR using image data is an important computer vision task with widespread applications in remote sensing for surveillance, object tracking, urban planning, agriculture, and more. Disclosed embodiments can be used to extract rich information from multimodal synthetic aperture radar (SAR) and electro-optical (EO) aerial images to perform object classification.

According to a preferred embodiment, there is provided a system for image classification, comprising: a computing device comprising at least a memory and a processor; an image preprocessing module comprising a first plurality of programming instructions stored in the memory and operable on the processor, wherein the first plurality of programming instructions, when operating on the processor, cause the computing device to: acquire a plurality of training images, wherein the training images include multiple sets of electro-optical images and synthetic aperture radar images; and perform one or more image manipulations on the training images; a label splitting module comprising a second plurality of programming instructions stored in the memory and operable on the processor, wherein the second plurality of programming instructions, when operating on the processor, cause the computing device to: augment the training images with metadata, wherein the metadata includes category information; and a neural network system module comprising a third plurality of programming instructions stored in the memory and operable on the processor, wherein the third plurality of programming instructions, when operating on the processor, cause the computing device to: implement a neural network system, wherein the neural network system includes a backbone layer, a first connected layer, and a second connected layer; and input the plurality of training images into the neural network system.

According to another preferred embodiment, there is provided a method for image classification, comprising steps of: acquiring a plurality of training images, wherein the training images include multiple sets of electro-optical images and synthetic aperture radar images; and performing one or more image manipulations on the training images; augmenting the training images with metadata, wherein the metadata includes category information; implementing a neural network system, wherein the neural network system includes a backbone layer, a first connected layer, and a second connected layer; and inputting the plurality of training images into the neural network system.

According to another preferred embodiment, there is provided a computer program product for an electronic computation device comprising a computer readable storage medium having program instructions embodied therewith, the program instructions executable by a processor to cause the electronic computation device to: acquire a plurality of training images, wherein the training images include multiple sets of electro-optical images and synthetic aperture radar images; and perform one or more image manipulations on the training images; augment the training images with metadata, wherein the metadata includes category information; implement a neural network system, wherein the neural network system includes a backbone layer, a first connected layer, and a second connected layer; and inputting the plurality of training images into the neural network system.

According to an aspect of an embodiment, an image preprocessing module comprises programing instructions stored in the memory and operable on the processor to perform a flip operation on at least one image from the plurality of training images.

According to an aspect of an embodiment, an image preprocessing module comprises programing instructions stored in the memory and operable on the processor to perform a rotation operation on at least one image from the plurality of training images.

According to an aspect of an embodiment, an image preprocessing module further comprises programing instructions stored in the memory and operable on the processor to perform an affine transform operation on at least one image from the plurality of training images.

According to an aspect of an embodiment, a label splitting module comprises programing instructions stored in the memory and operable on the processor to augment the training images with metadata that include category information of vehicle type categories.

According to an aspect of an embodiment, the label splitting module further comprises programing instructions stored in the memory and operable on the processor to include vehicle type categories of sedan, pickup truck, sport-utility vehicle (SUV), van, box truck, motorcycle, flatbed truck, bus, and trailer.

According to an aspect of an embodiment, the label splitting module comprises programing instructions stored in the memory and operable on the processor to utilize a KD-tree for appearance labeling.

According to an aspect of an embodiments, the label splitting module further comprises programing instructions stored in the memory and operable on the processor to perform triplet mining on the plurality of training images.

According to an aspect of an embodiment, there is provided a neural network system module comprising programing instructions stored in memory and operable on a processor to implement a backbone layer as a ResNet-34 layer.

According to an aspect of an embodiment, there is provided a neural network system module comprising programing instructions stored in memory and operable on a processor to implement a backbone layer as a Swin-T layer.

According to an aspect of an embodiment, there is provided a neural network system module comprising programing instructions stored in memory and operable on a processor to implement a backbone layer as an EfficientNet-B0 layer.

### BRIEF DESCRIPTION OF THE DRAWING FIGURES

FIG. 1 is a block diagram illustrating components for image classification utilizing EO image data and SAR image data, according to an embodiment.

FIG. 2 is a block diagram showing a network architecture, according to an embodiment.

FIG. 3 is a diagram of a neural network with a triplet loss component, according to an embodiment.

FIG. 4 shows exemplary EO image data and corresponding SAR image data, according to an embodiment.

FIG. 5 is a flow diagram illustrating an exemplary method for image classification utilizing EO image data and SAR image data, according to an embodiment.

FIG. 6 illustrates an exemplary computing environment on which an embodiment described herein may be implemented, in full or in part.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

Classifying objects in EO image data and SAR image data can be challenging for a variety of reasons, including long-tailed distribution of classes, a lack of pixel registration between EO image data and SAR image data, and overall and low image resolution. Disclosed embodiments address the aforementioned issues with a novel approach that includes label splitting, triplet loss functions, and appearance labeling. One or more embodiments can utilize a k-dimensional tree (KD-tree) to operate on features extracted using a Visual Geometry Group (VGG) network. The triplet loss function can cause samples of the same class to be closer to each other while samples of different classes are further apart from each other in the embedding space, enabling improved classification accuracy.

Visual Geometry Group (VGG) networks can include deep convolutional neural networks (CNNs) that can be used for image recognition. One or more embodiments can utilize a VGG-16 architecture and/or a VGG-19 architecture. In one or more embodiments, the VGG-16 and/or VGG-19 architectures can include 3×3 convolutional layers with max-pooling layers, followed by fully connected layers.

In embodiments, a KD-tree (K-dimensional tree) data structure is used for organizing points in a k-dimensional space. In embodiments, the KD-tree is implemented as a binary tree where each node represents an axis-aligned hyperrectangle (a region in the k-dimensional space) that divides the space into two parts. The splitting of the hyperrectangle may be performed based on the value of a single attribute (or dimension) of the data points at each level of the tree.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “pixel” refers to the smallest controllable element of a digital image. It is a single point in a raster image, which is a grid of individual pixels that together form an image. Each pixel has its own color and brightness value, and when combined with other pixels, they create the visual representation of an image on a display device such as a computer monitor or a smartphone screen.

The term “neural network” refers to a computer system modeled after the network of neurons found in a human brain. The neural network is composed of interconnected nodes, called artificial neurons or units, that work together to process complex information.

The term ‘synthetic aperture radar’ refers to a radar-based image acquisition technique in which a sequence of acquisitions from a shorter antenna are combined to simulate a much larger antenna, thus providing higher resolution data.

The term ‘electro-optical image’ refers to images captured with an electro-optical sensor, such as a high-resolution camera equipped with a telephoto zoom lens. The sensor detects the magnitude and color of emitted or reflected light and digitally records the information in the form of pixels.

### Conceptual Architecture

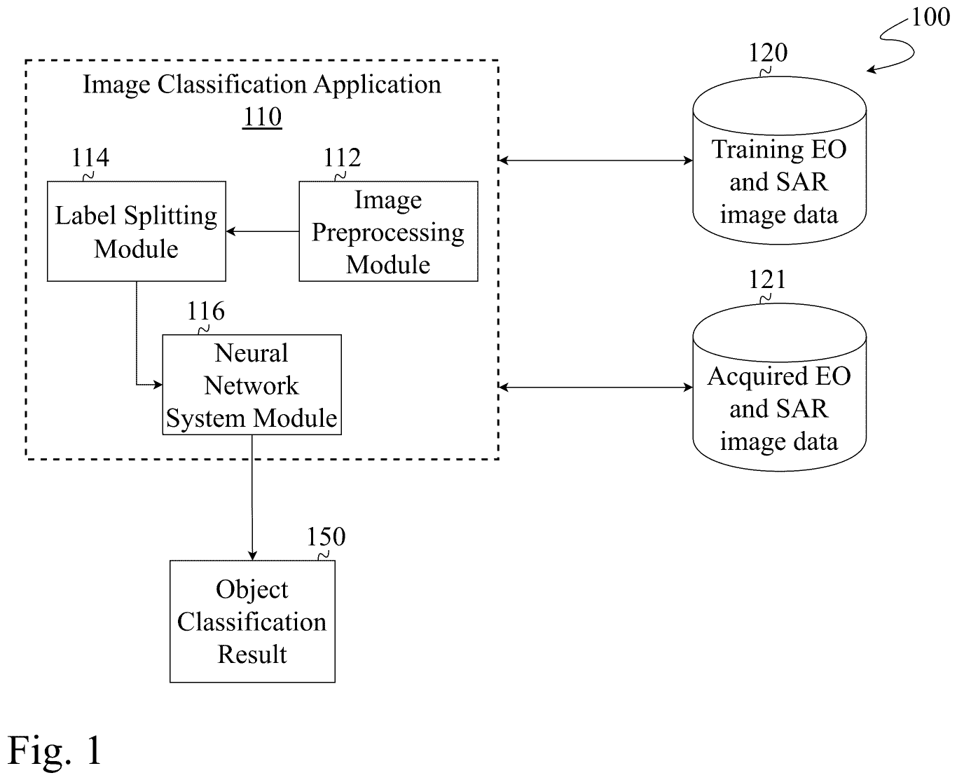

FIG. 1 is a block diagram illustrating a system 100 including components for image classification utilizing EO image data and SAR image data, according to an embodiment. The system 100 can include image classification application 110. Image classification application 110 can include one or more modules. The modules can include image preprocessing module 112. The image preprocessing module 112 can include functions and/or instructions, that when executed by a processor, cause the processor to perform one or more image preprocessing operations on input image data. The input image data can include training EO and SAR image data 120, and/or acquired EO and SAR image data 121. The training EO and SAR image data 120 can include data used to train a neural network system for object classification tasks. The acquired EO and SAR image data 121 can include image data that is provided as input to a trained neural network system to perform object classification tasks. In embodiments, the image data is in the form of pairs of EO images and corresponding SAR images. An EO image may have a similar field of view (FOV) as a corresponding SAR image in an image tuple. However, the EO image and corresponding SAR image might not have the same resolution, and may not have pixel registration with each other. The image tuple may be acquired from satellites and/or aircraft that include both EO and SAR image capturing devices onboard, enabling concurrent acquiring of EO image data and SAR image data of a given area.

The image preprocessing module 112 can include instructions to perform operations such as image resizing. In one or more embodiments, each image is resized to a predetermined size, such as 224×224, prior to being input to a neural network system. The image preprocessing module 112 can perform geometric operations. These geometric operations can include, but are not limited to, rotation, and/or flipping operations. The image preprocessing module 112 can include instructions to perform image enhancement operations, such as contrast adjustment and/or brightness adjustment. The image preprocessing module 112 may include instructions to perform an affine transform on input image data. An affine transformation is a type of geometric transformation that preserves points, straight lines, and planes. The affine transform can include a combination of translations, rotations, scales (anisotropic), and shears (skews), without any perspective distortion.

The label splitting module 114 can include functions and/or instructions, that when executed by a processor, cause the processor to augment training image data with metadata. The metadata can include category information. In one or more embodiments, the category information can include information for categories such as vehicles, buildings, geographical features, and so on. The geographical features can include features such as rivers, lakes, mountains, deserts, forests, and so on. The building types can include subcategories such as single-family dwellings, warehouses, skyscrapers, factories, and so on. The vehicle information can include subcategories such as sedan, sport-utility vehicle (SUV), pickup truck, van, box truck, motorcycle, flatbed truck, bus, trailer, pickup truck with trailer, flatbed truck with trailer, and so on. Moreover, the label splitting model 114 can include functions and/or instructions, that when executed by a processor, cause the processor to perform appearance labeling on image data. In one or more embodiments, the appearance labeling can include manual annotations and/or automated annotations that assign labels to EO image data and/or SAR image data based on the visual characteristics of the content. For example, in object detection, each object in an image may be labeled with a bounding box and a class label (e.g., “sedan,” “motorcycle,” “bus”). In one or more embodiments, the appearance labeling provides ground truth data that neural network systems of disclosed embodiments use to learn the relationships between input features (e.g., pixel values, texture, color) and the corresponding labels, enabling them to make predictions on new, unseen data, such as acquired EO and SAR image data 121 of FIG. 1.

The neural network system module 116 can include functions and/or instructions, that when executed by a processor, cause the processor to create a neural network with one or more modules, blocks, and/or layers. The layers can include a backbone layer, a first fully connected layer, and a second fully connected layer. The backbone can refer to the core architecture or structure of the network. The backbone is the main part of the network that is responsible for extracting features from the input EO and SAR image data. In embodiments, the backbone can include multiple layers of convolutional neural network (CNN) and/or other types of layers that are used for feature extraction. A fully connected layer is a type of layer in a neural network where each neuron in the layer is connected to every neuron in the preceding layer. In a fully connected layer, the output from each neuron in the preceding layer can be fed as input to each neuron in the current layer, and each connection is associated with a weight that is adjusted during the training process. The output of the neural network system can include an object classification result 150. The object classification result can include an object category, subcategory, confidence level, and/or other parameters. As an example, an object classification result can include a category of ‘vehicle,’ a subcategory of ‘pickup truck,’ and a confidence level of 0.932. The confidence level can be based on logits from an output layer. The output layer of a neural network for image classification can include a set of neurons, with each set corresponding to a class label. These neurons produce raw scores, also known as logits, which represent the network's confidence in each class. A mathematical function, such as a softmax function and/or other suitable function can be applied to the logits to convert them to probabilities.

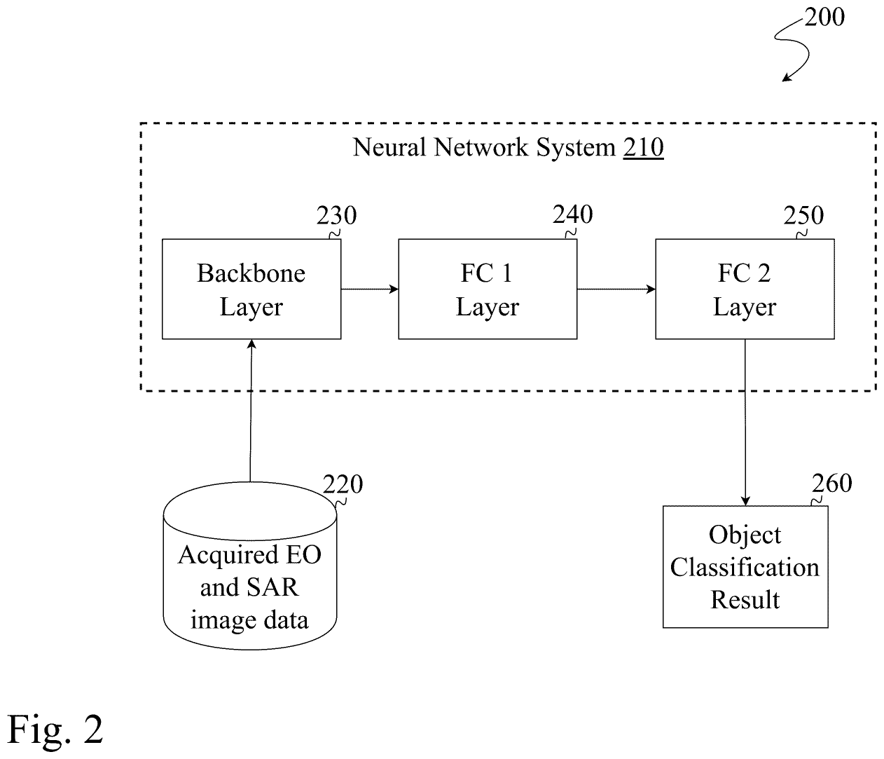

FIG. 2 is a block diagram showing a network architecture 200, according to an embodiment. The neural network architecture 200 can include neural network system 210. In one or more embodiments, the neural network system 210 may be configured and/or initialized by neural network system module 116 of FIG. 1. The neural network system 210 can include a backbone layer 230, followed by a first fully connected layer 240, and a second fully connected layer 250, configured as shown in FIG. 2. In one or more embodiments, the backbone layer 230 can include a ResNet layer. The ResNet (Residual Network) layer can include a deep convolutional neural network (CNN) that is well-suited for image classification tasks. In one or more embodiments, the backbone layer 230 can include a ResNet-34 layer. With ResNet-34, the network architecture consists of 34 layers, including convolutional layers, batch normalization layers, activation functions, and residual blocks. The network architecture is structured in a way that gradually reduces the spatial dimensions of the input while increasing the number of filters in each layer, leading to a hierarchical feature representation of the input images. The activation function can include a ReLU (Rectified Linear Unit) activation function. In embodiments, the ReLU activation function can be described mathematically as:

f(x)=max(0,x)

where the output of the ReLU function is the maximum of 0 and the input x. If the input is greater than 0, the output is equal to the input; otherwise, the output is 0. In one or more embodiments, the activation function can include a Leaky ReLU activation function. The Leaky ReLU (Rectified Linear Unit) is a type of activation function used in artificial neural networks. It is similar to the standard ReLU function but allows a small, non-zero gradient when the input is negative, instead of setting the gradient to zero. In one or more embodiments, the Leaky ReLU activation function is defined as follows:

$$f ( x ) = \{ \begin{matrix}x , & if x > 0 \\ α x , & otherwise\end{matrix}$$

Where α is a small constant, such as 0.01, that determines the slope of the function for negative inputs. This can serve to reduce the probability of developing inactive neurons during training and/or operational use of the neural network.

In one or more embodiments, the backbone layer 230 can include an EfficientNet layer. In particular embodiments, the backbone layer 230 can include an EfficientNet-B0 layer. The “B0” in EfficientNet-B0 refers to the baseline model in the EfficientNet series, which serves as the starting point for scaling up the model to achieve better performance. In embodiments, the EfficientNet model can be scaled by increasing the network's depth, width, and resolution in an approach to find an ideal tradeoff between model size and accuracy.

In one or more embodiments, the backbone layer 230 can include a transformer layer. In particular embodiments, the backbone layer 230 can include a Swin-T layer. A Swin Transformer (Swin-T) layer is a variant of the Transformer model architecture, which has suitability for computer vision tasks. In embodiments, the Swin Transformer provides a hierarchical architecture, which processes EO and SAR images in a hierarchical manner, similar to how humans perceive visual information. Embodiments utilizing Swin-T can divide the input image into non-overlapping patches and process these patches in a series of stages, or “windows,” each of which aggregates information across different scales and resolutions. In one or more embodiments, acquired EO and SAR image data 220 is input to the backbone layer 230, through first fully connected layer 240, and second fully connected layer 250, with the output of the second fully connected layer 250 being an object classification result 260, which can include an object category, subcategory, and/or confidence level.

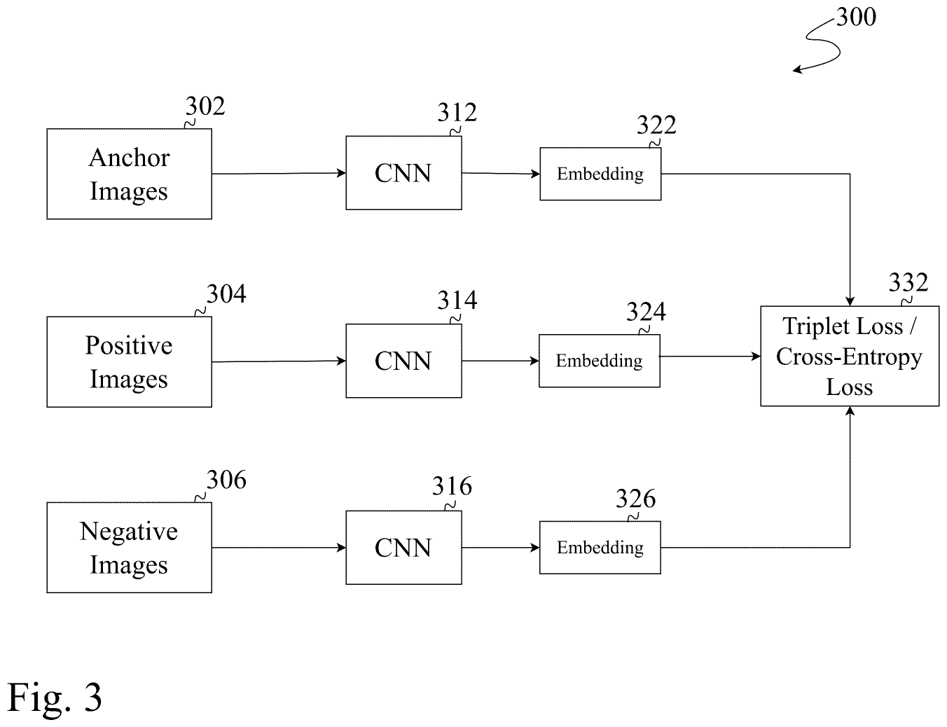

FIG. 3 is a diagram of a neural network 300 with a triplet loss component, according to an embodiment. Neural network 300 can serve as a training framework for object recognition of image tuples comprising EO image data and/or SAR image data. Training image data for neural network 300 can include anchor images 302, positive images 304, and negative images 306. The anchor images 302, positive images 304, and negative images 306 can include image tuples that include both EO image data and corresponding SAR image data. The anchor images 302 serve as reference images that form a starting point for comparing the similarity or dissimilarity of other images in the dataset. The positive images 304 include images that are similar to the anchor images in some way. For example, in vehicle type recognition, the positive images 304 can include different images of the same vehicle type as the anchor images 302. This can enable disclosed embodiments to learn to map both the anchor and positive images to similar points in an embedding space. The embedding space in image classification can refer to a lower-dimensional space where EO images and/or SAR images are represented as vectors. These vectors can include learned representations that capture important features or characteristics of the images to enable object classification. The negative images 306 include images that are dissimilar to the anchor images 302. In vehicle type identification tasks, a negative image can include an image of a different vehicle type from that included in the anchor images 302. Neural networks of disclosed embodiments are trained to map the anchor and negative images to dissimilar points in the corresponding embedding space.

As shown in FIG. 3, anchor images 302 are input to convolutional neural network (CNN) 312, which inputs to embedding space 322. Similarly, positive images 304 are input to convolutional neural network (CNN) 314, which inputs to embedding space 324, and negative images 306 are input to convolutional neural network (CNN) 316, which inputs to embedding space 326. In embodiments, the outputs of the embedding space 322, embedding space 324, and embedding space 326 are input to a triplet loss and/or cross entropy loss block 332.

Embodiments can include triplet mining. Triplet mining is a technique used in training neural networks for metric learning tasks, such as object recognition or similarity learning. The goal of triplet mining is to select informative triplets of data points (anchor, positive, and negative) that are used to train the network effectively. In triplet mining, each training example can include an anchor data point, a positive data point (similar to the anchor), and a negative data point (dissimilar to the anchor). The network is trained to minimize the distance between the anchor and positive data points (in the embedding space) while maximizing the distance between the anchor and negative data points, effectively learning to discriminate between similar and dissimilar data points. Similarly, cross-entropy loss, also known as log loss, is another loss function used in machine learning for classification tasks in disclosed embodiments. The cross-entry loss can measure the difference between two probability distributions: the predicted probability distribution output by the model and the actual probability distribution of the labels. Disclosed embodiments can utilize both triplet loss and cross-entropy loss to enhance object classification effectiveness. In one or more embodiments, the embeddings have a dimension of 512 for calculating the triplet loss.

In embodiments, a cross-entropy loss function can be denoted as L_{CE} and the triplet loss function Lₜᵣᵢₚₗₑₜ can be defined as:

$${L}_{triplet} = max ( d ( {\hat{x}}_{a} , {\hat{x}}_{p} ) - d ( {\hat{x}}_{a} - {\hat{x}}_{p} ) + margin , 0 )$$

and a multi-loss function, Lₘᵤₗₜᵢ₋ₗₒₛₛ, can be defined as a combination of the cross-entropy loss and the triplet loss as follows:

$${L}_{multi - loss} = α * {L}_{triplet} + ( 1 - α ) * {L}_{CE}$$

where \hat{x}ₐᵢ∈R^{d} is the ith feature that belongs to the yᵢth class. d, W∈R^{d×n}, and b∈R^{d} denote the feature dimension, last connected layer, and bias term, respectively. \hat{x}ₐ, \hat{x}ₚ, and îₙ are the anchor, positive image, and negative image, respectively. In one or more embodiments, the regularization term, or a, used for training the multi-loss loss function can be set to a value of 0.8. Other values for the regularization term may be used in some embodiments.

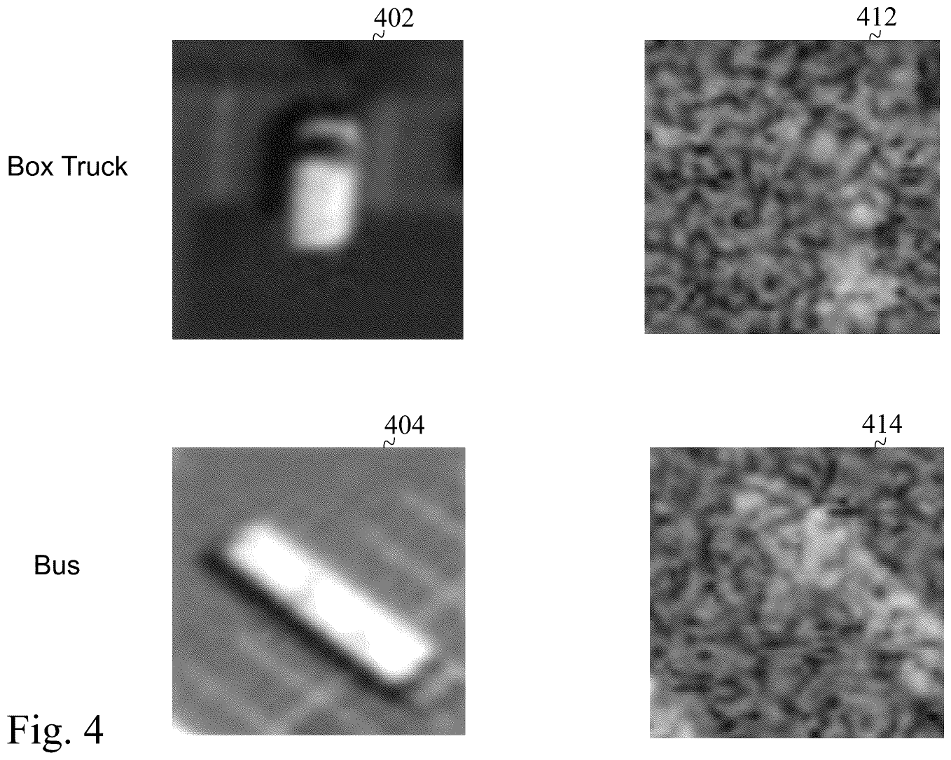

FIG. 4 shows exemplary EO image data and corresponding SAR image data, according to an embodiment. Image 402 includes an aerial EO image of a box truck. Image 412 is a corresponding SAR image of the box truck. Thus, image 402 and image 412 can form an image tuple. In another example, image 404 is an aerial EO image of a bus. Image 414 is a corresponding SAR image of the bus. Thus, image 404 and image 414 can also form an image tuple. Disclosed embodiments can operate on EO images, SAR images, and/or image tuples to perform object classification.

### DETAILED DESCRIPTION OF EXEMPLARY ASPECTS

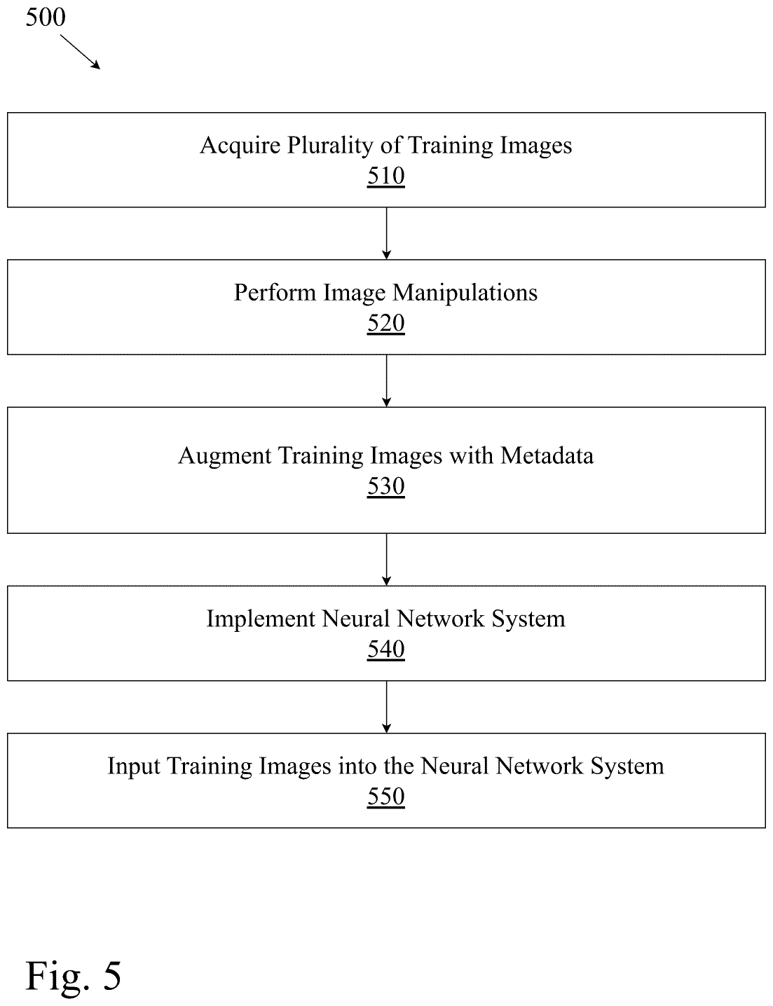

FIG. 5 is a flow diagram illustrating an exemplary method 500 for image classification utilizing EO image data and SAR image data, according to an embodiment. According to the embodiment, the process begins at step 510 where a plurality of training images are acquired. In one or more embodiments, these images can be acquired by a satellite and/or aircraft that can acquire both EO (Electro-Optical) images and SAR (Synthetic Aperture Radar) images. An example of such satellites can include Sentinel-1, which is part of the European Union's Copernicus program. The Sentinel-1 satellites are equipped with SAR sensors that provide all-weather, day-and-night radar imaging for land and ocean services. Moreover, numerous research and commercial aircraft are equipped with EO systems and SAR systems for remote sensing applications. These aircraft can acquire SAR images along with other sensors for EO imaging. The process continues to step 520 where image manipulations are performed. The image manipulations may include rotation, flipping, scaling, denoising, contrast enhancement, edge detection, resizing operations, pixel registration operations, affine transforms, and/or other suitable manipulations. The process continues to step 530 where training images are augmented with metadata. The metadata can include descriptive information, such as a category and/or subcategory. The metadata can include appearance labeling information. The metadata can include label splitting information. The label splitting information can include multiple attributes for a category, to further aid in performing object classification on acquired image data. The process continues to step 540 for the implementation of a neural network system. In one or more embodiments, the neural network system may be configured using a cloud-based machine learning platform such as Google Cloud AI Platform, Amazon SageMaker, Microsoft Azure Machine Learning, or other suitable cloud platform. One or more embodiments may utilize containerization technologies such as Docker and Kubernetes to package the neural network code and dependencies into containers. The containers may then be deployed to cloud-based container orchestration services like Amazon ECS, Google Kubernetes Engine (GKE), or Azure Kubernetes Service (AKS). The containers may support machine learning frameworks such as TensorFlow, PyTorch, and/or other suitable frameworks. The process continues to step 550, where training images are input into the neural network system. The neural network may support a triplet loss function, and the input training data can include anchor data, positive data, and negative data. The input training data can be in the form of image tuples that include EO image data and corresponding SAR image data.

### Exemplary Computing Environment

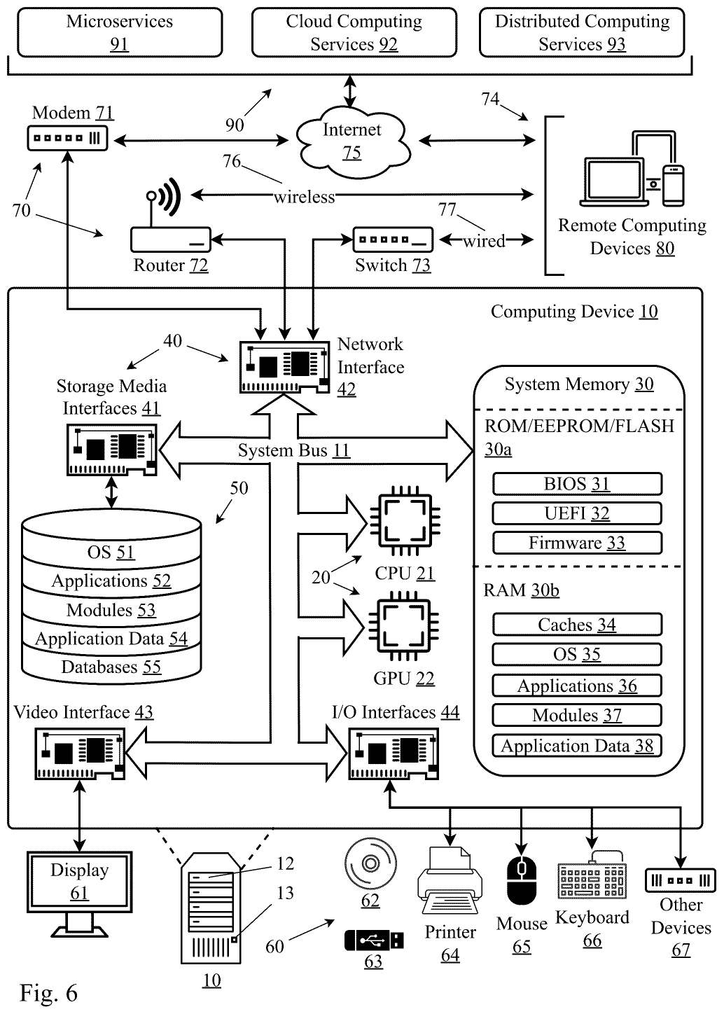

FIG. 6 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can now be appreciated, disclosed embodiments provide improvements in object classification of image data that includes EO images and/or SAR images. Disclosed embodiments are well-suited for automatic identification of objects in images from aerial and/or satellite imagery. Automating the classification process reduces the need for manual intervention, leading to faster analysis of satellite images and quicker decision-making. Additionally, by reducing the need for manual labor, automatic classification provided by disclosed embodiments can serve to lower the overall cost of analyzing satellite and/or aerial images. Moreover, automated classification methods can provide objective and repeatable analysis, reducing the potential for bias in the interpretation of satellite and/or aerial images. Thus, disclosed embodiments provide automatic object classification in EO and/or SAR image data that enhances the efficiency, scalability, accuracy, and timeliness of the image analysis, making disclosed embodiments valuable for various applications in environmental monitoring, urban planning, agriculture, and more.

The skilled person will be aware of a range of possible modifications of the various aspects described above. Accordingly, the present invention is defined by the claims and their equivalents.

1. A system for image classification, comprising:
a computing device comprising at least a memory and a processor;
an image preprocessing module comprising a first plurality of programming instructions stored in the memory and operable on the processor, wherein the first plurality of programming instructions, when operating on the processor, cause the computing device to:
acquire a plurality of training image tuples, wherein the training image tuples comprise a paired electro-optical image and a corresponding synthetic aperture radar image; and
perform one or more image manipulations on the training image tuples;
a label splitting module comprising a second plurality of programming instructions stored in the memory and operable on the processor, wherein the second plurality of programming instructions, when operating on the processor, cause the computing device to:
augment the training image tuples with metadata, wherein the metadata includes category information; and
a neural network system module comprising a third plurality of programming instructions stored in the memory and operable on the processor, wherein the third plurality of programming instructions, when operating on the processor, cause the computing device to:
implement a neural network system, wherein the neural network system includes a backbone layer, a first connected layer, and a second connected layer;
process each image tuple through the neural network system by inputting both the electro-optical image and the corresponding synthetic aperture radar image of the tuple; and
generate an object classification result for the image tuple based on the paired processing of both images in the tuple.

2. The system of claim 1, wherein the image preprocessing module further comprises programing instructions stored in the memory and operable on the processor to perform a flip operation on at least one image from the plurality of training image tuples.

3. The system of claim 1, wherein the image preprocessing module further comprises programing instructions stored in the memory and operable on the processor to perform a rotation operation on at least one image from the plurality of training images.

4. The system of claim 1, wherein the image preprocessing module further comprises programing instructions stored in the memory and operable on the processor to perform an affine transform operation on at least one image from the plurality of training image tuples.

5. The system of claim 1, wherein the label splitting module further comprises programing instructions stored in the memory and operable on the processor to augment the training image tuples with metadata that include category information of vehicle type categories.

6. The system of claim 5, wherein the label splitting module further comprises programing instructions stored in the memory and operable on the processor to include vehicle type categories of sedan, pickup truck, sport-utility vehicle (SUV), van, box truck, motorcycle, flatbed truck, bus, and trailer.

7. The system of claim 1, wherein the label splitting module further comprises programing instructions stored in the memory and operable on the processor to utilize a KD-tree for appearance labeling.

8. The system of claim 1, wherein the label splitting module further comprises programing instructions stored in the memory and operable on the processor to perform triplet mining on the plurality of training image tuples.

9. The system of claim 1, wherein the neural network system module further comprises programing instructions stored in the memory and operable on the processor to implement the backbone layer as a ResNet-34 layer.

10. The system of claim 1, wherein the neural network system module further comprises programing instructions stored in the memory and operable on the processor to implement the backbone layer as an EfficientNet-B0 layer.

11. The system of claim 1, wherein the neural network system module further comprises programing instructions stored in the memory and operable on the processor to implement the backbone layer as a Swin-T layer.

12. A method for image classification, comprising steps of:
acquiring a plurality of training image tuples, wherein the training images include multiple sets of tuples comprise a paired electro-optical image and a corresponding synthetic aperture radar image; and
performing one or more image manipulations on the training image tuples;
augmenting the training images with metadata, wherein the metadata includes category information;
implementing a neural network system, wherein the neural network system includes a backbone layer, a first connected layer, and a second connected layer;
processing each image tuple through the neural network system by inputting both the electro-optical image and the corresponding synthetic aperture radar image of the tuple; and
generating an object classification result for the image tuple based on the paired processing of both images in the tuple.

13. The method of claim 12, wherein performing one or more image manipulations comprises performing a flip operation.

14. The method of claim 12, wherein performing one or more image manipulations comprises performing a rotation operation.

15. The method of claim 12, wherein performing one or more image manipulations comprises performing an affine transform operation.

16. The method of claim 12, further comprising augmenting the training image tuples with metadata that include category information of vehicle type categories.

17. The method of claim 16, wherein the vehicle type categories include sedan, pickup truck, sport-utility vehicle (SUV), van, box truck, motorcycle, flatbed truck, bus, and trailer.

18. The method of claim 12, further comprising performing triplet mining on the plurality of training image tuples.

19. The method of claim 12, further comprising performing appearance labeling on the plurality of training image tuples.

20. (canceled)
